(19) United States
(12) Patent Application Publication
(10) Pub. No.: US 2026/0270724 A1
(43) Pub. Date: Sep. 10, 2026

(54) Cellular Network Slicing with Reinforcement Learning and Proximal Policy Optimization

(71) Applicant: Dell Products L.P., Round Rock, TX (US)

(72) Inventor: Yasser AlEryani, Kanata (CA)

(21) Appl. No.: 19/074,129

(22) Filed: Mar. 7, 2025

(51) Int. Cl. H04W 24/02; H04B 17/309

(52) U.S. Cl. CPC H04W 24/02; H04B 17/309

(57) ABSTRACT

A system can identify a group of key performance indicator measurements based on broadband cellular communications to be communicated to a group of user equipment. The system can input the group of key performance indicator measurements to a deep reinforcement learning agent, wherein the deep reinforcement learning agent comprises a nonlinear reward function, and wherein an output of the deep reinforcement learning agent comprises an allocation of network slices for the broadband cellular communications. The system can communicate the broadband cellular communications to the group of user equipment based on the allocation of network slices.

### BACKGROUND

A base station can facilitate broadband cellular communications with user equipment.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can identify a group of key performance indicator measurements based on broadband cellular communications to be communicated to a group of user equipment. The system can input the group of key performance indicator measurements to a deep reinforcement learning agent, wherein the deep reinforcement learning agent comprises a nonlinear reward function, and wherein an output of the deep reinforcement learning agent comprises an allocation of network slices for the broadband cellular communications. The system can communicate the broadband cellular communications to the group of user equipment based on the allocation of network slices.

An example method can comprise identifying, by a system comprising at least one processor, key performance indicator measurements based on broadband cellular communications with user equipment. The method can further comprise inputting, by the system, key performance indicator measurements to a deep reinforcement learning agent, wherein the deep reinforcement learning agent comprises a nonlinear reward function, and wherein an output of the deep reinforcement learning agent comprises an allocation of network slices for the broadband cellular communications. The method can further comprise facilitating, by the system, the broadband cellular communications based on the allocation of network slices.

An example non-transitory computer-readable medium can comprise instructions that, in response to execution, cause a system comprising a processor to perform operations. These operations can comprise inputting key performance indicator measurements to a deep reinforcement learning agent, wherein the deep reinforcement learning agent comprises a nonlinear reward function, wherein an output of the deep reinforcement learning agent comprises an allocation of network slices for broadband cellular communications to be conducted with user equipment, and wherein the key performance indicator measurements are based on the broadband cellular communications to be conducted with the user equipment. These operations can further comprise conducting the broadband cellular communications based on the allocation of network slices.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate cellular network slicing with reinforcement learning and proximal policy optimization, in accordance with an embodiment of this disclosure;

FIG. 2 illustrates an example table of different key performance indicators (KPIs) to be concatenated within a state space vector, as an input to a deep reinforcement learning (DRL) system, and that can facilitate cellular network slicing with reinforcement learning and proximal policy optimization, in accordance with an embodiment of this disclosure;

FIG. 3 and FIG. 4 illustrate an example table of action space elements, and that can facilitate cellular network slicing with reinforcement learning and proximal policy optimization, in accordance with an embodiment of this disclosure;

FIG. 5 illustrates an example table of approaches for when throughput energy (TP_{Energy}) and throughput indicator for instantaneous measurement (TP_{IM}) contradict for different network slices, and that can facilitate cellular network slicing with reinforcement learning and proximal policy optimization, in accordance with an embodiment of this disclosure;

FIG. 6 illustrates an example of hyperparameter tuning, training, and model evaluation, and that can facilitate cellular network slicing with reinforcement learning and proximal policy optimization, in accordance with an embodiment of this disclosure;

FIG. 7 illustrates an example of physically integrating cellular network slicing with reinforcement learning and proximal policy optimization into an Open Radio Access Network (O-RAN) architecture, in accordance with an embodiment of this disclosure;

FIG. 8 illustrates an example of logically integrating cellular network slicing with reinforcement learning and proximal policy optimization into an O-RAN architecture, in accordance with an embodiment of this disclosure;

FIG. 9 illustrates an example process flow that can facilitate cellular network slicing with reinforcement learning and proximal policy optimization, in accordance with an embodiment of this disclosure;

FIG. 10 illustrates another example process flow that can facilitate cellular network slicing with reinforcement learning and proximal policy optimization, in accordance with an embodiment of this disclosure;

FIG. 11 illustrates another example process flow that can facilitate cellular network slicing with reinforcement learning and proximal policy optimization, in accordance with an embodiment of this disclosure; and

FIG. 12 illustrates an example block diagram of a computer operable to execute an embodiment of this disclosure.

### DETAILED DESCRIPTION

### Overview

While the present examples generally relate to fifth generation (5G) broadband cellular networks, it can be appreciated that they can be applied to other types of broadband cellular networks, such as sixth generation (6G) broadband cellular networks.

The present techniques can provide a deep reinforcement learning (DRL) framework for dynamic network slicing and resource management in heterogeneous networks. The present techniques can employ a reward function that integrates the following key performance indicators (KPIs): network load (NL), slice utilization (SU), user demand (UD), link quality (LQ), latency (L), resource availability (RA), energy consumption (EC), and quality of service (QoS) deviation (QD). Each KPI can be assigned a normalized weight to reflect its relative importance, which can ensure a balanced and comprehensive evaluation of network performance. To address the possibility of nonlinear degradation in network performance, the reward function can incorporate nonlinear transformations of the KPIs. These transformations, such as quadratic penalties and exponential decay terms, can allow a system according to the present techniques to capture nonlinear relationships and penalize large deviations from optimal KPI values more accurately. Where the examples described herein mention an optimal value, or another superlative, it can be appreciated that there can be examples where the value is satisfactory but not optimal.

This capture of nonlinear relationships can ensure that the present techniques account for a complex, nonlinear nature of network degradation, resulting in more effective decision-making by the DRL agent. The DRL agent can make optimized decisions by considering the time-averaged values of each KPI, leveraging a sliding window or exponentially weighted moving average (EWMA) for continuous KPI measurement. This approach can provide stability and reliability in decision-making, allowing the system to dynamically adapt to changing network conditions and user demands while maintaining high performance and energy efficiency. By incorporating relevant KPIs and normalizing their weights, the present techniques can ensure a fair and holistic assessment of network performance, leading to improved user experiences and efficient resource utilization. This DRL-based network management approach can address the complexity of next-generation networks, offering a robust method for optimizing network slicing and resource allocation in real-time.

With the advent of 5G and the anticipated transition to 6G, the landscape of telecommunications is undergoing a profound transformation. This evolution brings about significant challenges in managing network resources efficiently while ensuring high-quality service delivery to diverse applications and user demands. Prior static resource management techniques fall short in addressing the dynamic and heterogeneous nature of modern networks. The present techniques introduce a DRL framework designed to optimize network slicing and resource allocation in real-time. By leveraging a multi-KPI reward function, the framework can ensure a balanced and comprehensive assessment of network performance, facilitating improved decision-making processes.

Network slicing can enable multiple virtual networks to be created on a single physical infrastructure. Each slice can be tailored to meet specific service requirements, such as enhanced mobile broadband (eMBB), ultra-reliable low-latency communications (URLLC), and massive machine-type communications (mMTC). This flexibility can be crucial for supporting diverse use cases ranging from high-speed internet access to critical IoT applications.

Efficient resource management in such an environment can be challenging due to the following factors:
Dynamic network conditions: User demand, network load, and link quality can vary significantly over time, necessitating adaptive resource allocation strategies.
Diverse service requirements: Different services can have unique performance requirements, such as latency, bandwidth, and reliability, and it can be specified that they be met synchronously.
Energy efficiency: As networks expand, the need for energy-efficient operations can become increasingly important to reduce operational costs and environmental impact.
Quality of service (QoS) assurance: Maintaining high QoS levels across all network slices can be threshold desirable for user satisfaction and regulatory compliance.

DRL can be utilized to address complex decision-making problems. By interacting with the environment and learning from the consequences of actions, DRL agents can develop optimal policies for resource management. In the context of network slicing, a DRL agent can dynamically adjust resource allocation based on real-time network conditions and performance metrics.

An aspect of DRL is the design of the reward function, which guides the learning process by providing feedback on the quality of actions taken. A reward function can:
Reflect critical aspects of network performance.
Balance competing objectives, such as latency vs. energy consumption.
Provide stable and interpretable feedback to the learning agent.

The present techniques can incorporate a DRL-based framework that integrates a comprehensive reward function incorporating these KPIs:
Mid-haul network interface load: To manage congestion and ensure efficient resource utilization.
Slice utilization: To optimize the use of allocated resources within each network slice.
User demand: To align resource allocation with varying user demand patterns.
Link quality: To maintain high-quality connections and minimize packet loss.
Latency: To ensure low latency for time-sensitive applications.
Resource availability: To maximize the efficient use of available resources (CPU, memory, bandwidth).
Energy consumption: To promote energy-efficient network operations.
QoS deviation: To minimize deviations from QoS requirements for all services.

Each KPI can be assigned a normalized weight to reflect its relative importance, which can facilitate ensuring that the reward function provides a balanced assessment of network performance. The present techniques can employ a sliding window or exponentially EWMA to maintain and update the time-averaged values of each KPI, which can ensure stability and reliability in the learning process.

By incorporating relevant KPIs and normalizing their weights, the present techniques can ensure a fair and holistic evaluation of network performance. This approach can enable the network to adapt dynamically to changing conditions, optimize resource utilization, and maintain high QoS levels, ultimately leading to enhanced user experiences and more efficient network operations.

In heterogeneous network environments, managing network slicing and resource allocation can be a challenge due to the diverse and dynamic nature of user demands and service requirements. Prior static or rule-based resource management approaches can fall short in addressing the complexities of these networks. Issues include:
Dynamic network conditions: Rapid fluctuations in user demand and network conditions can require real-time adaptation, which static methods cannot provide.
Multi-metric optimization: Balancing multiple key performance indicators (KPIs) such as latency, resource utilization, energy consumption, and quality of service (QoS) can be complex and often conflicting.
Service diversity: Different service types (e.g., enhanced mobile broadband (eMBB), ultra reliable and low latency communications (URLLC), and massive machine type communication (mMTC)) have unique requirements that can necessitate tailored resource management strategies.
Energy efficiency: Increasing energy consumption in network operations can require solutions that optimize performance while minimizing energy use.

Addressing these challenges can require a dynamic approach capable of optimizing multiple KPIs simultaneously, adapting to real-time changes, and accommodating diverse service requirements to ensure efficient and high-performance network operations.

The present techniques can be implemented to incorporate several novel aspects that distinguish it from existing approaches in the domain of network slicing and resource management for heterogeneous networks. These aspects can include:
Comprehensive multi-KPI reward function: The present techniques can employ a reward function that integrates nine KPIs, providing a holistic and balanced assessment of network performance. This approach contrasts with prior approaches that often focus on a limited subset of performance metrics. Example KPIs used in the present techniques are:
   Network load;
   Slice utilization;
   User demand;
   Link quality;
   Latency;
   Resource availability;
   Energy consumption; and
   Quality of service (QoS) deviation.
Each KPI can be assigned a normalized weight, ensuring that the reward function reflects the relative importance of each metric. This comprehensive multi-KPI approach can allow for more nuanced and effective optimization of network resources.
Dynamic adaptation using DRL: The use of DRL to dynamically adapt network slicing and resource allocation can be an advancement relative to prior approaches. Prior static or rule-based approaches can fail to cope with the rapidly changing conditions in modern networks. The DRL framework according to the present techniques can continuously learn and improve its policy by interacting with the network environment, making real-time decisions that optimize network performance. This ability to adapt dynamically can ensure robust and efficient network operations.
Time-averaged KPI measurement: To ensure stability and reliability in the decision-making process, the present techniques can employ time-averaged values for each KPI, calculated using a sliding window or exponentially EWMA. This technique can smooth out short-term fluctuations, and provide a more accurate representation of long-term network performance trends. This approach can enhance the robustness of the optimization process, leading to more consistent and reliable network management.
Normalized weight assignment: The normalized weight assignment for each KPI can ensure a balanced consideration of all performance metrics. The weights can be calculated as:

$${w}_{i}^{′} = \frac{{w}_{i}}{{\sum }_{j = 1}^{9} \vert {w}_{j} \vert}$$

This normalization process can ensure that the reward function is not dominated by any single KPI, promoting a fair and holistic evaluation of network performance. This balanced approach can be implemented for optimizing multiple, often conflicting, network objectives simultaneously.
Real-time resource allocation and network slicing: An ability to perform real-time resource allocation and network slicing according to the present techniques can represent an advancement over prior static approaches. By leveraging the DRL framework, a system that implements the present techniques can quickly respond to changes in network conditions and user demands, ensuring optimal resource utilization and high-quality service delivery. This real-time capability can be used for managing the complexities of next-generation networks.
Energy efficiency considerations: Incorporating energy consumption as a KPI and optimization for energy efficiency can address a growing need for sustainable network operations. By including energy consumption in the reward function, the present techniques can promote energy-efficient practices, reducing operational costs and environmental impact without compromising network performance.
Versatile application across service types: The present techniques can accommodate diverse requirements of different service types, such as eMBB, URLLC, and mMTC. The ability to balance the needs of these varied services within a unified framework can ensure that service types receive the necessary resources to meet their specific performance requirements.
Robustness and Scalability: The DRL-based framework can be inherently scalable and robust, capable of managing large and complex network environments. The use of DRL can allow a system that implements the present techniques to scale efficiently as the network grows, maintaining high performance and effective resource management across a wide range of scenarios.

An objective of the present techniques can be to optimize (or satisfactorily improve) network slicing and resource allocation in a heterogeneous network environment using a DRL framework. The optimization can aim to maximize overall network performance by considering multiple KPIs and adapting to dynamic network conditions.

The performance of the network can be evaluated based on the following KPIs:
Mid-haul Internet Protocol (IP) network interface load (NL): The overall load on the network infrastructure.
Slice utilization (SU): The utilization of resources allocated to each network slice.
User demand (UD): The demand for network resources from users.
Link quality (LQ): The quality of the communication links in the network.
Latency (LL): The time delay experienced by data packets.
Resource availability (RA): The availability of network resources (e.g., central processing unit (CPU), memory, bandwidth).
Energy consumption (EC): The amount of energy consumed by the network.
QoS deviation (QD): The deviation from the required QoS levels.

An objective function r_{avg} can be designed to provide feedback to the DRL agent based on the performance of the network. Furthermore, to address the occasional nonlinear degradation of different KPIs, nonlinear terms can be incorporated into the reward function. Specifically, the reward function can be formulated to include quadratic terms or other nonlinear transformations of the KPIs. This can make it so that the optimization process is not allowed to penalize deviations from optimal KPI values more severely when they become large, capturing potential nonlinear degradation effects.

An example modification to the reward function is:

$${r}_{avg} = {\sum }_{i = 1}^{8} {w}_{i}^{′} \cdot {f}_{i} ( {KPI}_{i} )$$

where:
   KPIᵢ: is the i^{th} average KPI (e.g., N̅L̅, S̅U̅, Q̅o̅S̅, etc.).
   ƒᵢ(KPIᵢ): is a nonlinear function that captures the nonlinear relationship between the i^{th} KPI and its contribution to the reward function.

$${w}_{i}^{′} , … , {w}_{9}^{′}$$

are the normalized weights assigned to each KPI. These weights are determined as:

$${w}_{i}^{′} = \frac{{w}_{i}}{{\sum }_{j = 1}^{9} \vert {w}_{j} \vert}$$

For example, quadratic or exponential forms can be used.

A quadratic term can penalize large deviations of KPIs from their desired values more severely:

$${f}_{i} ( {KPI}_{i} ) = ( {KPI}_{i} - {KPI}_{i}^{*} )$$

where

$${KPI}_{i}^{*}$$

is the estimated optimal value for the i^{th} KPI.

Exponential decay or growth functions can emphasize the importance of small changes in KPIs, which can lead to rapid degradation in performance:

$${f}_{i} ( {KPI}_{i} ) = {e}^{- {α}_{i} ( {KPI}_{i} - {KPI}_{i}^{*} )}$$

where αᵢ is a scaling factor that controls the sensitivity of the exponential function.

Piecewise-defined functions can be used to capture different regimes of behavior, such as:

$${f}_{i} ( {KPI}_{i} ) = \{ \begin{matrix}{w}_{i}^{′} \cdot {KPI}_{i} , & {KPI}_{i} \leq {KPI}_{i}^{*} \\ {w}_{i}^{′} \cdot {KPI}_{i}^{2} , & {KPI}_{i} > {KPI}_{i}^{*}\end{matrix}$$

This formulation can allow for linear treatment when the KPI is within acceptable limits, and can introduce stronger penalties when the KPI exceeds a certain threshold.

Nonlinear modifications can facilitate the following. With regard to nonlinear degradation of network performance, KPIs such as latency, link quality, or resource availability can exhibit nonlinear degradation patterns. For instance, as latency increases beyond a threshold, user experience can degrade exponentially rather than linearly. Similarly, a small decrease in resource availability can have minimal impact initially, but after a certain point, network performance can degrade rapidly.

With regard to adaptive sensitivity to different KPIs, by introducing nonlinear terms, the reward function can be made more sensitive to specific KPIs or ranges of KPI values that are critical to overall network performance. This can allow a learning agent to more effectively prioritize the mitigation of large degradations in performance.

With regard to flexibility in modeling complex network dynamics, nonlinear functions can provide greater flexibility in modeling the complex interdependencies between different KPIs. For example, it can be that the relationship between network load and user demand is not straightforward, and a nonlinear approach can capture such complexities more effectively.

In summary, by incorporating these nonlinear transformations, it can be ensured that the deep reinforcement learning (DRL) agent more accurately reflects the performance dynamics of the network, leading to more robust and reliable optimization results.

The average values of different KPIs can be calculated as follows:
Average overall mid-haul network interface load (NL):

$$\overline{NL} = \frac{1}{T} {\sum }_{t = 1}^{T} {NL}_{1} ( t )$$

Where T is the overall averaging window time.
Average slice utilization (SU):

$$\overline{SU} = [ \frac{1}{T} {\sum }_{t = 1}^{T} {SU}_{1} ( t ) , … , \frac{1}{T} {\sum }_{t = 1}^{T} {SU}_{s} ( t ) ]$$

Where s∈{1, . . . , S}, S is the maximum number of slices of the network.
Average per-slice user demand (UD):

$$\overline{UD} = [ \frac{1}{T} {\sum }_{t = 1}^{T} {UD}_{1} ( t ) , … , \frac{1}{T} {\sum }_{t = 1}^{T} {UD}_{S} ( t ) . ]$$

Average link quality (LQ):

$$\overline{LQ} = \frac{1}{T} {\sum }_{t = 1}^{T} Q ( t )$$

Average per-slice latency (L):

$$\overline{L} = [ \frac{1}{T} {\sum }_{t = 1}^{T} {L}_{1} ( t ) , … , \frac{1}{T} {\sum }_{t = 1}^{T} {L}_{S} ( t ) . ]$$

Average resource availability (RA):

$$\overline{RA} = \frac{1}{T} {\sum }_{t = 1}^{T} RA ( t ) .$$

Practical implications: With regard to dynamic balancing of service types, by calculating the average service type requirement over time, the network management system can ensure that resources are allocated in a way that meets the diverse and changing requirements of all service types effectively. With regard to temporal optimization, average service type requirement over time can help the DRL agent to recognize the temporal patterns and trends in service type demands, enabling more informed and adaptive resource allocation decisions. With regard to enhanced adaptability, as the network conditions and user demands change dynamically, the DRL framework can adjust the resource allocation to maintain an optimal balance based on the average service type requirements over time.
Average energy consumption (EC):

$$\overline{EC} = \frac{1}{T} {\sum }_{t = 1}^{T} EC ( t ) .$$

Average per-slice deviation on QoS (QD):

$$\overline{QD} = [ \frac{1}{T} {\sum }_{t = 1}^{T} {QD}_{1} ( t ) , … , \frac{1}{T} {\sum }_{t = 1}^{T} {QD}_{s} ( t ) ] .$$

An optimization problem according to the present techniques can be formulated as:

$${max}_{π} {\sum }_{i = 1}^{8} {w}_{i} \cdot {f}_{i} ( {KPI}_{i} )$$

$${\sum }_{s} {Resource}_{s} \leq Total Available Resources$$

$$Subject to : {L}_{s} \leq Max {Latency}_{s} , {∀}_{s}$$

$$QoS {eviation}_{s} \leq Max QoS {Deviation}_{s} , {∀}_{s}$$

$$EC \leq Max Energy Consumption {∀}_{s} ,$$

$$( {KPI}_{1}^{s} ) \cdot ( {KPI}_{2}^{s} ) … ( {KPI}_{{K}_{s}}^{s} ) \geq {KPI}_{P F}^{S}$$

where π is the network slicing policy that has direct impact on the objective function ƒ(x). Further details are given below. Additionally:

$${KPI}_{{k}_{s}}^{s} :$$

defines the performance metric of the

$${k}_{s}^{th}$$

UE of the S^{th} slice.
   KPI: defines the lower limit for a proportional fair (PF) metric for the given performance metric (PM). It can be adjusted for a given targeted performance. KPI∈{N̅L̅,S̅U̅, U̅D̅,L̅Q̅, L̅L̅,R̅A̅, E̅C̅,Q̅D̅}.

A DRL system according to the present techniques can be implemented as follows.

With regard to RAN-based state space KPIs, the state space for a DRL system can be defined by a set of KPIs that represent the current status of the network. These KPIs can be derived from 3rd Generation Partnership Project (3GPP) and Radio Access Network (RAN)/Open Radio Access Network (O-RAN) measurements, and provide a comprehensive view of the network's performance and resource utilization. The following KPIs can be included in the state space, with the following example extraction methods (where the extraction methods are examples using 3GPP and O-RAN standards, and there can be other extraction methods in different scenarios):
Network load: Real-time measurement of network traffic load.
   Extraction method: Use Packet Data Convergence Protocol (PDCP) Service Data Unit (SDU) Volume from 3GPP TS 32.425 and O1 Traffic Load Report from ORAN.WG2.O1 Interface Specification.
Slice utilization: The current usage level of each network slice.
   Extraction method: Utilize Slice Resource Usage Report and O1 Interface Slice Utilization from O-RAN Performance Metrics.
User demand: The number of active users and their respective data demands.
   Extraction method: Extract using User Equipment (UE) Context from 3GPP Technical Specification (TS) 32.421 and Active User Report from ORAN.WG1.O1 Interface Specification.
Link quality: Signal strength and interference levels for various links.
   Extraction method: Measure using channel quality indicator (CQI) Report, reference signal received power (RSRP), and reference signal received quality (RSRQ) from 3GPP TS 36.214 and TS 38.215, and Link Quality Metrics from O-RAN.
Latency measurements: Real-time latency metrics for different slices.
   Extraction method: Collect using end-to-end (E2E) Latency and Packet Delay Budget (PDB) from 3GPP TS 23.501 and TS 29.244, and Latency Report from ORAN.WG2.O2 Interface Specification.
Resource availability: Available central processing unit (CPU), memory, and bandwidth resources.
   Extraction method: Monitor using network functions virtualization infrastructure (NFVI) Resource Status and O-Cloud Resource Metrics from O-RAN.
Energy consumption: Power usage metrics for different network components.
   Extraction method: Measure using Power Consumption Report from 3GPP TS 32.425, and Energy Efficiency Metrics from O-RAN.
QoS deviation: The deviation from the desired QoS levels.
   Extraction method: Compare using QoS Monitoring Control and QoS Threshold Crossing Alert from 3GPP TS 23.501, and QoS Deviation Report from O-RAN.

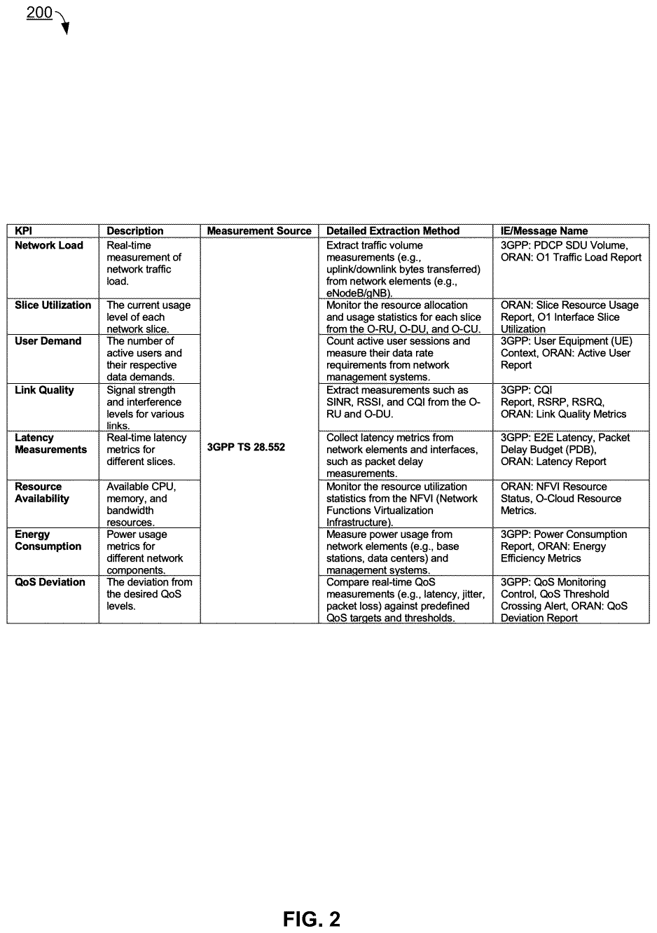

Table 200 of FIG. 2 illustrates examples of different KPIs to be concatenated within the state space vector, as an input to the DRL system.

A state space for the DRL system can be defined by combining the KPIs into a single vector. This vector can represent the current status of the network, and can serve as the input to the DRL system. Below is the vector form of the state space, along with an illustrative example:

Let S denote the state space vector. The vector S can be expressed as:

$$S = [ NL ( t ) , SU ( t ) , UD ( t ) , LQ ( t ) , L ( t ) , RA ( t ) , EC ( t ) , QD ( t ) ]$$

In an example, consider a scenario where the network has the following measurements:
Network load (NL): 70% (indicating 70% of the network capacity is currently utilized);
Slice utilization (SU): [50%, 80%, 30%](utilization levels of three different network slices);
User demand (UD): 1200 active users with varying data demands;
Link quality (LQ): [CQI: 15, RSRP: −90 decibels milliwatt (dBm), RSRQ: −10 dB] for a particular link;
Latency (L): 30 millisecond (ms) average latency for a specific slice;
Resource availability (RA): [CPU: 60%, Memory: 70%, Bandwidth: 50%] availabilities;
Energy consumption (EC): 500 kilowatt hours (kWh) for the current period; and
QoS deviation (QD): 5% deviation from the desired QoS levels.

The state space vector S for this example can be expressed as:

$$S = 70 , [ 50 , 80 , 30 ] , 1200 , [ 15 , - 90 , - 10 ] , 30 , [ 60 , 70 , 50 ] , [ 60 , 30 , 10 ] , Historical Data , 500 , 5 ]$$

Breakdown of the state space vector:
network load: 70
Slice utilization: [50, 80, 30]
User demand: 1200
Link quality: [15, −90, −10]
Latency: 30
Resource availability: [60, 70, 50]
Service type: [60, 30, 10]
Historical data: (represented as a complex structure to predict future trends)
Energy consumption: 500
QoS deviation: 5

Each element of the vector S can provide information about the network's performance and resource utilization, enabling the DRL system to make informed decisions for dynamic management and optimization.

The action space for the DRL system can be defined by a set of discrete and continuous actions that can be taken to manage and optimize network slices. These actions can be represented as vectors in a high-dimensional space, where each element corresponds to a specific control parameter or decision variable. The primary categories of actions can include managing slice types and performing other necessary network optimizations.

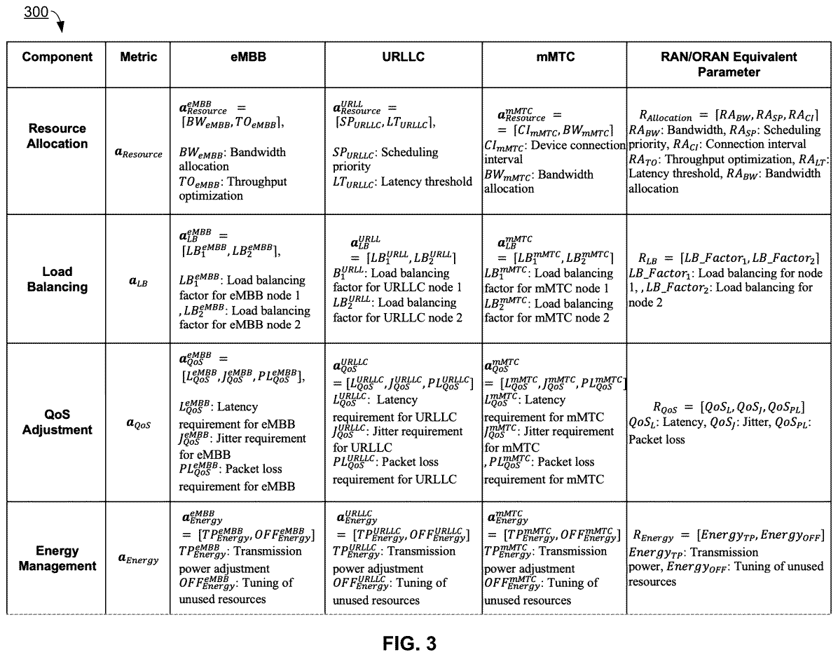

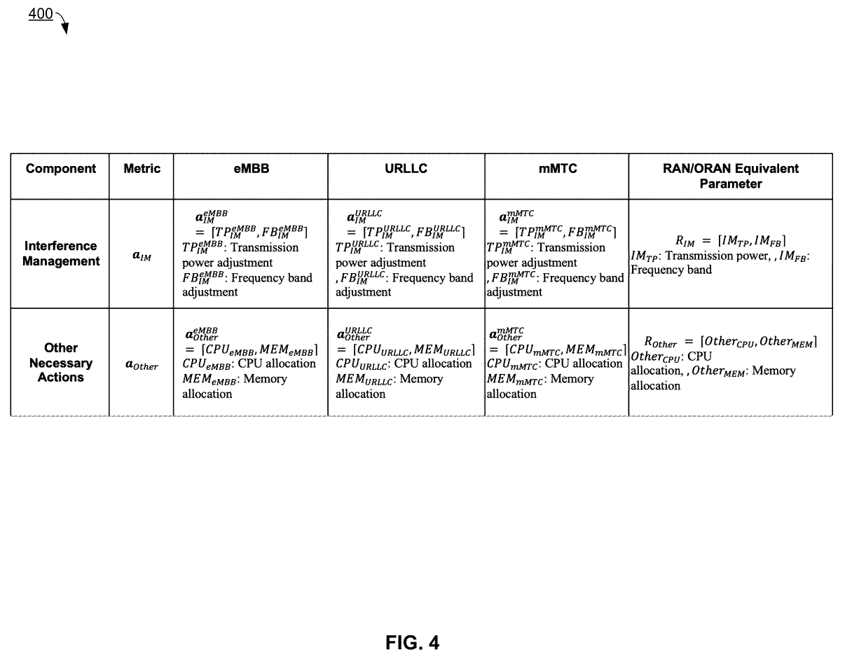

Table 300 of FIG. 3 and table 400 of FIG. 4 illustrate example action space elements, with a brief description of each element.

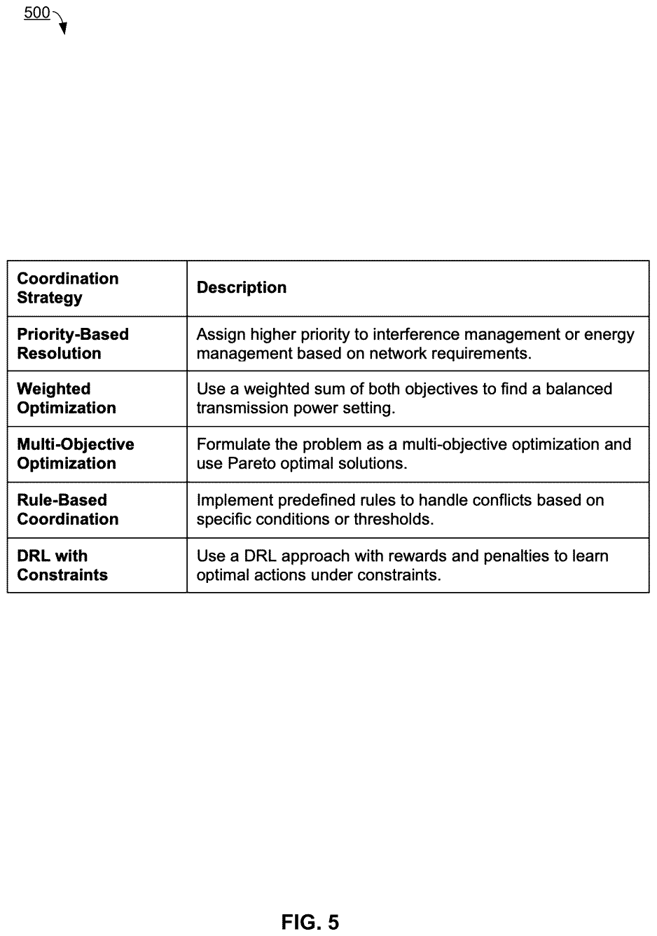

For the slices in table 300, when throughput energy (TP_{Energy}) and throughput indicator for instantaneous measurement (TP_{IM}) contradict, the approaches illustrated in table 500 of FIG. 5 can be used to coordinate them.

An example coordination strategy can be priority-based with fallback:
Primary objective: Ensure interference management.
Secondary objective: Optimize energy usage without compromising interference constraints.
   Step 1: Apply TP_{IM} to manage interference.
   Step 2: Check energy consumption. If within acceptable limits, proceed. If above limits, apply a reduced TP_{IM} that balances interference and energy constraints.

Coordination can be monitored through the following approach:
Input: Current interference level I, current energy consumption E, and thresholds
I_{threshold}, E_{threshold}.
Apply TP_{IM} to manage interference.
Measure resulting energy consumption E′.

if E′ ≤ E_{threshold}:
Accept I_{IM}
else:

Adjust TP_{IM} to balance interference and energy:

$${TP}_{adjusted} = α \cdot {TP}_{IM} + ( 1 - α ) \cdot {TP}_{Energy}$$

where α is a balancing factor.
Output: Final transmission power setting.

The combined action space A of the DRL system can be represented as a concatenation of all individual action vectors:

$${A}_{Overall} = [ \begin{matrix}{A}_{eMBB} \\ {A}_{URLL} \\ {A}_{mMTC}\end{matrix} ] ,$$

where,

$${A}_{eMBB} = [ \begin{matrix}{a}_{Resource}^{eMBB} \\ {a}_{LB}^{eMBB} \\ {a}_{QoS}^{eMBB} \\ {a}_{Energy}^{eMBB} \\ {a}_{IM}^{eMBB} \\ {a}_{Other}^{eMBB}\end{matrix} ]$$

$${A}_{URLL} = [ \begin{matrix}{a}_{Resource}^{URLL} \\ {a}_{LB}^{URLL} \\ {a}_{QoS}^{URLL} \\ {a}_{Energy}^{URLL} \\ {a}_{IM}^{URLL} \\ {a}_{Other}^{URLL}\end{matrix} ]$$

$${A}_{mMTC} = [ \begin{matrix}{a}_{Resource}^{mMTC} \\ {a}_{LB}^{mMTC} \\ {a}_{QoS}^{mMTC} \\ {a}_{Energy}^{mMTC} \\ {a}_{IM}^{mMTC} \\ {a}_{Other}^{mMTC}\end{matrix} ]$$

An example of combined action space in O-RAN, with specific parameters, is as follows:

$$A = [ \begin{matrix}{a}_{eMBB} = [ \begin{matrix}5 \\ 10 \\ 15\end{matrix} ] \\ \begin{matrix}{a}_{URLL} = [ \begin{matrix}1 \\ 2\end{matrix} ] \\ {a}_{mMTC} = [ \begin{matrix}50 \\ 100 \\ 150\end{matrix} ] \\ {a}_{CPU} = [ \begin{matrix}70 \% \\ 60 \% \\ 80 \%\end{matrix} ] \\ {a}_{LB} = [ \begin{matrix}25 \\ 30\end{matrix} ] \\ {a}_{QoS} = [ \begin{matrix}100 \\ 20 \\ 0.01\end{matrix} ] \\ {a}_{Energy} = [ \begin{matrix}10 \\ 2\end{matrix} ] \\ {a}_{IM} = [ \begin{matrix}15 \\ 5\end{matrix} ]\end{matrix}\end{matrix} ]$$

where,
eMBB parameters can represent different bandwidth allocations or throughput targets.
URLLC parameters can denote latency and reliability targets.
mMTC parameters likely represent the number of connected devices or data rates.
Resource allocation (RA) parameters are percentages of CPU, memory, and bandwidth allocated.
Load balancing (LB) parameters can be the number of users or sessions distributed.
QoS adjustment (QoS) parameters specify latency, jitter, and packet loss requirements.
Energy management (Energy) parameters include transmission power and the number of resource units turned off for energy saving.
Interference management (IM) parameters manage transmission power and frequency band adjustments to mitigate interference.

In some examples, this high-dimensional vector can encompass all possible actions the DRL agent can take to manage and optimize the network slices, ensuring comprehensive control over the network resources and performance.

By structuring the action space in this technical manner, the DRL system can effectively learn and execute policies to optimize network performance in O-RAN environments.

An O-RAN slicing reward function can be implemented as follows. The time-averaged reward function can be defined similarly to the instantaneous reward function but using time-averaged KPI measurements. Let X̅ denote the time-averaged value of the KPI X.

$${r}_{avg} = {\sum }_{i = 1}^{8} {w}_{i} \cdot {f}_{i} ( {KPI}_{i} )$$

In the context of designing a reward function for a reinforcement learning (RL) system, it can be that the weights w₁ to w₉ do not sum to one. A goal of the weights can be to appropriately scale the contributions of each KPI to the overall reward according to their relative importance. However, normalizing the weights such that their sum equals one can make the reward function more interpretable and ensure that each KPI's contribution is proportional. This normalization can be useful when comparing different scenarios or tuning the weights.

Consider a scenario where the DRL system is managing the network, and the following measurements are observed, time averaged over a period (e.g., 10 minutes):
average network load: 65%
average slice utilization: [55%, 75%, 35%]:

$$\frac{55 + 75 + 35}{3} = 55 \%$$

average user demand: 1150/1475 active users
average link quality: [CQI: 14, RSRP: −88 dBm, RSRQ: −9 dB]
average latency: 28 ms
average resource availability: [CPU: 62%, Memory: 68%, Bandwidth: 52%]
average energy consumption: 480 kWh
average QoS deviation: 4%

For this example, assume the following weights:

$$w 1 = - 0.5 ( penalize high network load )$$

$${w}_{2} = 0.3 ( reward good slice utilization )$$

$${w}_{3} = 0.4 ( reward high user satisfaction )$$

$${w}_{4} = 0.2 ( reward good link quality )$$

$${w}_{5} = - 0.6 ( penalize high latency )$$

$${w}_{6} = 0.3 ( reward high resource availability )$$

$${w}_{7} = - 0.1 ( penalize high energy consumption )$$

$${w}_{8} = - 0.4 ( penalize high QoS deviation )$$

Accordingly, the normalized weights are then given as:

$${w}_{1}^{′} = - 0.167 ( penalize high network load )$$

$${w}_{2}^{′} = 0.1 ( reward good slice utilization )$$

$${w}_{3}^{′} = 0.133 ( reward high user satisfaction )$$

$${w}_{4}^{′} = 0.067 ( reward good link quality )$$

$${w}_{5}^{′} = - 0.2 ( penalize high latency )$$

$${w}_{6}^{′} = 0.1 ( reward high resource availability )$$

$${w}_{7}^{′} = - 0.033 ( penalize high energy consumption )$$

$${w}_{8}^{′} = - 0.133 ( penalize high QoS deviation )$$

Given these measurements and weights:
Network load: 65% (penalty: −0.5.65=−32.5−0.5·65=−32.5)
Average slice utilization: (55%+75%+35%)/3≈55%
(reward: 0.3·55=16.50·3.55=16.5)
User satisfaction: Assume a satisfaction score of 78%
(reward: 0.4·78=31.20·4.78=31.2)
Link quality: Assume a combined score of 68 out of 100
(reward: 0.2·68=13.60·2.68=13.6)
Latency: 28 ms (penalty: −0.6·28=−16.8−0.6·28=−16.8)
Energy consumption: 480 kWh (penalty: −0.1·480=−48−0.1·480=−48)
QoS deviation: 4% (penalty: −0.4·4=−1.6−0.4·4=−1.6)
Summing these up:

$${r}_{avg} = - 32.5 + 16.5 + 31.2 + 13.6 - 16.8 - 48 - 1.6 = - 37.6$$

The time-averaged reward −37.6 still indicates suboptimal performance but may differ from the instantaneous value, providing a more stable basis for learning and decision-making.

Advantages of time-averaged measurements can include:
Stability: Reduces the impact of outliers and transient spikes in KPI values.
Robustness: Provides a more reliable reflection of network performance over time.
Smooth learning curve: Helps the DRL agent to learn more consistent policies by focusing on long-term trends rather than reacting to short-term variations.

To implement time-averaged measurements, a sliding window or an EWMA for each KPI can be maintained:

$$\overline{X} ( t ) = α \cdot X ( t ) + ( 1 - α ) \cdot \overline{X} ( t - 1 )$$

Where α is the smoothing factor that determines how much weight is given to the latest measurement.

By incorporating these time-averaged measurements into the reward function, the DRL system can make more informed and stable decisions, leading to better overall network performance.

Designing a DRL system for optimizing O-RAN can involve selecting the architecture and parameters to address the complexity and scale of the network management problem. The following describes technical design details, including the network architecture, activation functions, DRL algorithms, and other critical aspects.

It can be that the neural network used in the DRL system is to be capable of handling high-dimensional state and action spaces. An example architecture for this kind of problem can include:
Input layer: Corresponds to the state space KPIs, which can include, for example, hundreds of features.
Hidden layers: Several fully connected layers to capture the relationships between the KPIs.
Output layer: Represents the action space, providing the probabilities or values for each possible action.

The following can be an example architecture of a DRL system according to the present techniques:
Input layer: Size equal to the number of KPIs (e.g., 100 neurons).
Hidden layer 1: 256 neurons, fully connected.
Hidden layer 2: 128 neurons, fully connected.
Hidden layer 3: 64 neurons, fully connected.
Output layer: Size equal to the number of possible actions (e.g., 10 neurons).

Activation functions can play a role in introducing non-linearity into the network, allowing it to learn mappings from inputs to outputs. Example activation functions used in DRL systems include:
ReLU (rectified linear unit): Used in the hidden layers for efficiency and to mitigate the vanishing gradient problem.
Softmax: Used in the output layer for policy-based methods to represent a probability distribution over actions.
Linear: May be used in the output layer for value-based methods to represent Q-values.

Different DRL techniques can be used for managing and optimizing an O-RAN. The choice of technique can depend on the specific requirements and constraints of the problem. Example techniques include:
Deep Q-network (DQN): This can be suitable for discrete action spaces. It uses a neural network to approximate the Q-value function.
Proximal policy optimization (PPO): A policy gradient method that can be stable and efficient for both discrete and continuous action spaces.
Actor-critic methods: Combines value-based and policy-based methods, using two networks (actor and critic) for better stability and performance.
Deep deterministic policy gradient (DDPG): Suitable for continuous action spaces, often used in combination with an actor-critic architecture.

Training includes:
Experience replay: Storing past experiences in a replay buffer to break the correlation between consecutive samples and improve training stability (such as in a DQN).
Mini-batch Gradient Descent: Training the network using mini-batches from the replay buffer to improve convergence.
Discount factor (γ): For example, set between 0.9 and 0.99 to balance the importance of immediate and future rewards.
Learning rate: A small learning rate (e.g., 0.001) can be used to facilitate stable convergence.

Loss Functions can include:
Mean squared error (MSE): For example, can be used in value-based methods like DQN.
Policy gradient loss: For example, can be used in policy-based methods to maximize the expected return.
Entropy regularization: For example, can be added to the loss function in some algorithms (e.g., PPO) to encourage exploration.

The following is an example configuration example for the O-RAN slicing system using DRL technique:

### Neural Network Architecture:

Input layer: 100 neurons (corresponding to KPIs)
Hidden layer 1: 256 neurons, ReLU activation
Hidden layer 2: 128 neurons, ReLU activation
Hidden layer 3: 64 neurons, ReLU activation
Output layer: 10 neurons (corresponding to actions), Softmax activation (for policy-based) or Linear activation (for value-based)

### DRL Algorithm: PPO (Proximal Policy Optimization)

### Training Parameters:

Experience replay: Yes (for DQN)
Mini-batch Size: 64
Discount factor (γ): 0.99
Learning rate: 0.001

### Loss Functions:

Value loss: mean squared error (MSE)
Policy loss: policy gradient loss
Entropy regularization: Yes (for PPO)

Through designing the neural network architecture, selecting appropriate activation functions, and choosing suitable DRL algorithms, a system according to the present techniques can effectively learn and adapt to optimize network performance in an O-RAN environment. This can ensure that the DRL system is robust, scalable, and capable of handling the complexities of modern network management.

Hyperparameter tuning can be implemented to optimize the performance of the DRL model. This can involve experimenting with different values for several parameters to find a selected configuration.
Learning rate: Start with a small value (e.g., 0.001) and adjust based on training performance.
Batch size: Common values range from 32 to 256. Larger batch sizes can stabilize training but may require more memory.
Discount factor (γ): In some examples, varies between 0.9 and 0.99, balancing the trade-off between immediate and future rewards.
Entropy coefficient: In policy gradient methods, this parameter encourages exploration. Example values range from 0.01 to 0.1.
Clip range (for PPO): This can determine the range for clipping the policy update to prevent large updates. Example values range from 0.1 to 0.3.

Evaluating the performance of a DRL model in the context of O-RAN can involve several metrics:
Reward over time: Monitoring the cumulative reward during training to ensure the model is learning effectively.
Latency reduction: Measuring the average latency before and after optimization to confirm improvements.
Resource utilization: Assessing CPU, memory, and bandwidth usage to ensure efficient allocation.
Quality of Service (QoS) Compliance: Ensuring the network meets predefined QoS requirements for various services.

Deploying a DRL system in a live O-RAN environment can involve consideration of factors, such as:
Scalability: It can be that the system must handle the scale of the network, including the number of users and the volume of data.
Real-time processing: It can be that the DRL agent must make decisions in near real-time to be effective in a dynamic environment.
Robustness: It can be that the system should be resilient to changes in network conditions and capable of continuous learning and adaptation.
Security: There can be measurements to ensure that the DRL system and its interactions with the network are secure from malicious attacks.

An example workflow is as follows:
Data collection: Gather KPIs from the O-RAN radio unit (O-RU), O-RAN distributed unit (O-DU), and O-RAN centralized unit (O-CU).
Preprocessing: Normalize and preprocess the data to form the state space.
Training: Train the DRL model using historical data and simulations.
Validation: Validate the model using a separate dataset or in a controlled environment.
Deployment: Deploy the trained model in the live network.
Monitoring: Continuously monitor performance and make necessary adjustments.

The present techniques facilitate a framework for dynamic network slicing and resource management using a deep reinforcement learning agent. By incorporating nonlinear reward functions, the framework is capable of addressing nonlinear degradation in network performance, which can facilitate optimized resource utilization and high-quality service delivery in 5G and beyond networks. The present techniques offer a scalable and adaptive solution for managing the complexities of next-generation telecommunications networks.

### Example Architecture, Tables, Etc.

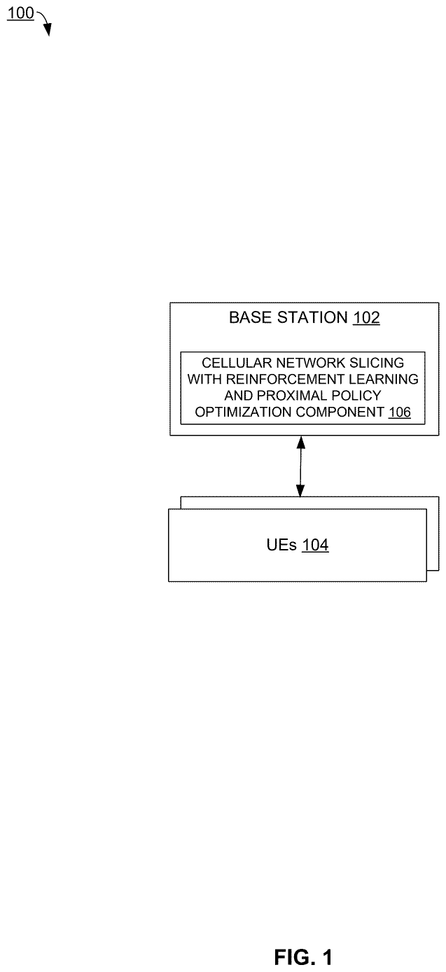

FIG. 1 illustrates an example system architecture 100 that can facilitate cellular network slicing with reinforcement learning and proximal policy optimization, in accordance with an embodiment of this disclosure.

System architecture 100 comprises base station 102 and UEs 104. Base station 102 comprises cellular network slicing with reinforcement learning and proximal policy optimization component 106.

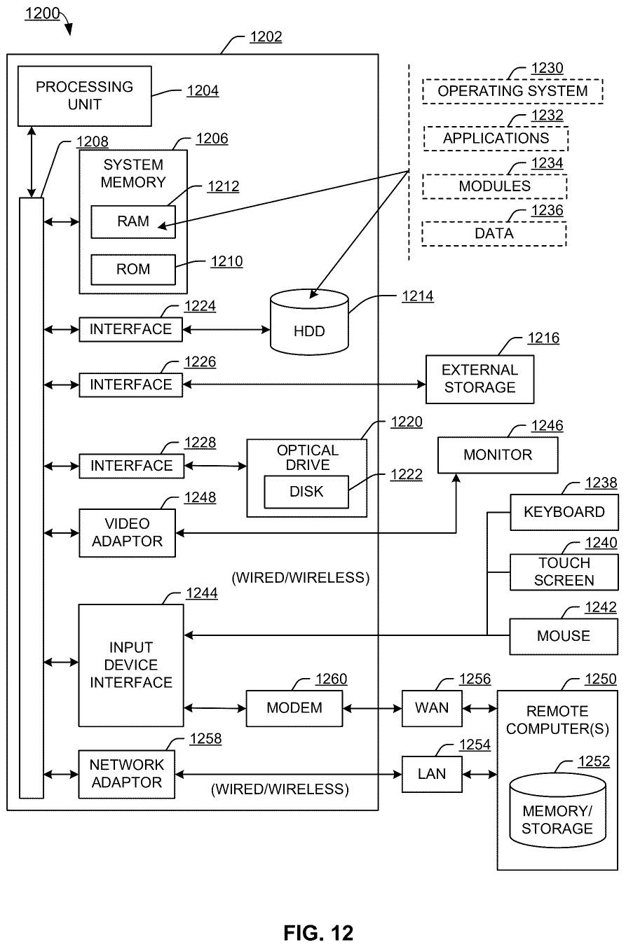

Each of base station 102 and/or UEs 104 can be implemented with part(s) of computing environment 1200 of FIG. 12.

Base station 102 can facilitate broadband cellular communications (e.g., 5G communications) with each UE of UEs 104. Cellular network slicing with reinforcement learning and proximal policy optimization component 106 can use KPIs determined from these broadband cellular communications and a DRL agent to determine how to perform network slicing to facilitate various services (e.g., a URLLC service).

In general, network slicing can comprise creating a virtual network on top of the broadband cellular network that is customized to a particular service.

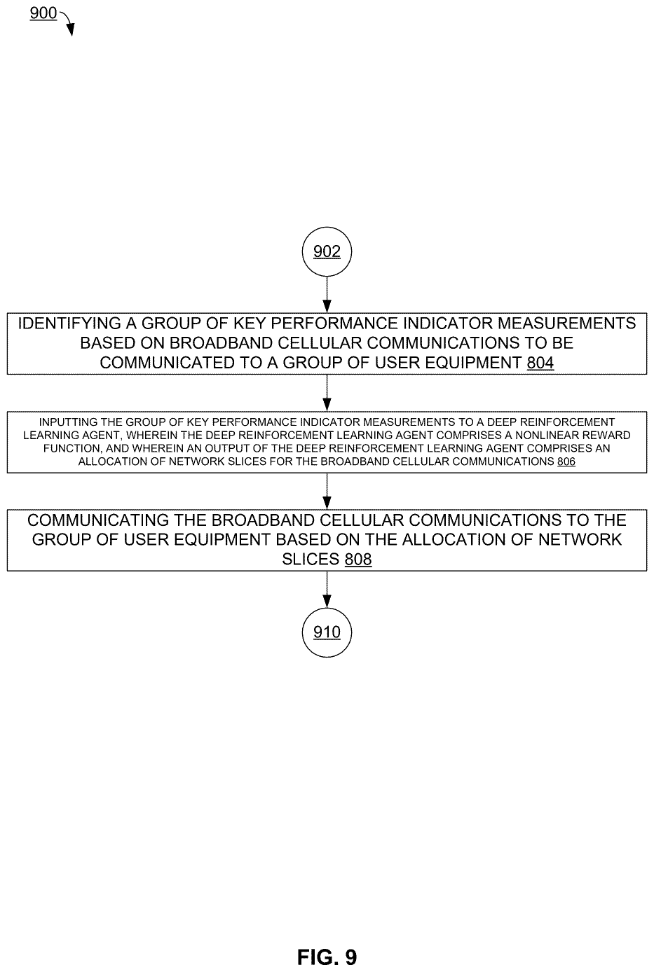

In some examples, cellular network slicing with reinforcement learning and proximal policy optimization component 106 can implement part(s) of the process flows of FIGS. 9-11 to implement cellular network slicing with reinforcement learning and proximal policy optimization.

It can be appreciated that system architecture 100 is one example system architecture for cellular network slicing with reinforcement learning and proximal policy optimization, and that there can be other system architectures that facilitate cellular network slicing with reinforcement learning and proximal policy optimization.

FIG. 2 illustrates an example table 200 of different key performance indicators (KPIs) to be concatenated within a state space vector, as an input to a deep reinforcement learning (DRL) system, and that can facilitate cellular network slicing with reinforcement learning and proximal policy optimization, in accordance with an embodiment of this disclosure. In some examples, part(s) of table 200 can be implemented by part(s) of system architecture 100 of FIG. 1 to facilitate cellular network slicing with reinforcement learning and proximal policy optimization.

FIG. 3 and FIG. 4 illustrate an example table (comprising table 300 and table 400) of action space elements, and that can facilitate cellular network slicing with reinforcement learning and proximal policy optimization, in accordance with an embodiment of this disclosure. In some examples, part(s) of table 300 and table 400 can be implemented by part(s) of system architecture 100 of FIG. 1 to facilitate cellular network slicing with reinforcement learning and proximal policy optimization.

FIG. 5 illustrates an example table 500 of approaches for when throughput energy (TP_{Energy}) and throughput indicator for instantaneous measurement (TP_{IM}) contradict for different network slices, and that can facilitate cellular network slicing with reinforcement learning and proximal policy optimization, in accordance with an embodiment of this disclosure. In some examples, part(s) of table 500 can be implemented by part(s) of system architecture 100 of FIG. 1 to facilitate cellular network slicing with reinforcement learning and proximal policy optimization.

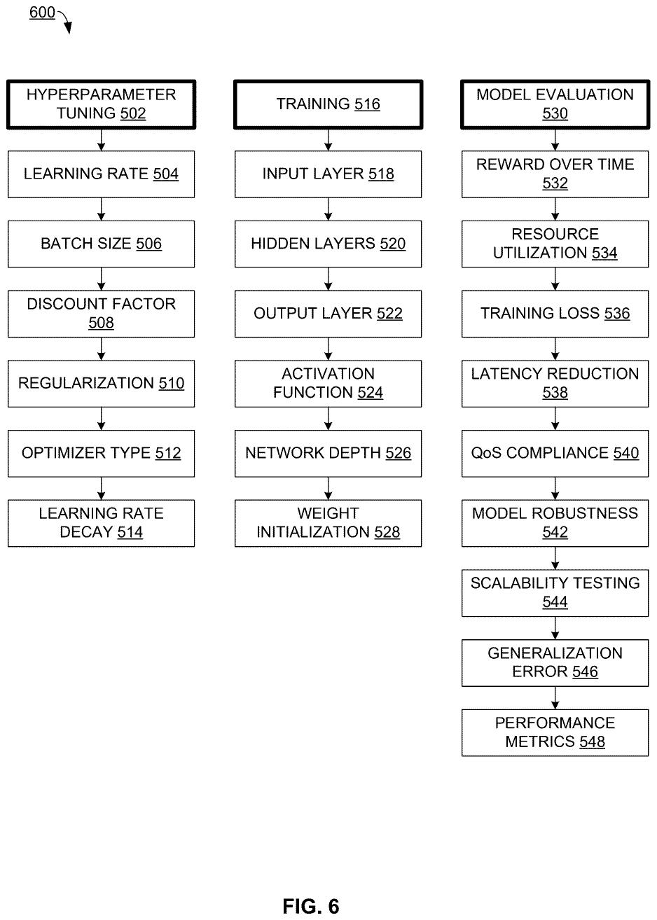

FIG. 6 illustrates an example 600 of hyperparameter tuning, training, and model evaluation, and that can facilitate cellular network slicing with reinforcement learning and proximal policy optimization, in accordance with an embodiment of this disclosure. In some examples, part(s) of example 600 can be implemented by part(s) of system architecture 100 of FIG. 1 to facilitate cellular network slicing with reinforcement learning and proximal policy optimization.

To illustrate the different processes and parameters, example 600 illustrates aspects of hyperparameter tuning and model evaluation.

Example 600 comprises the following components.

Hyperparameter tuning 602:
Learning rate 604: Controls the step size during the optimization.
Batch size 606: Number of samples processed before the model is updated.
Discount factor 608: Used in reinforcement learning to balance immediate and future rewards.
Regularization 610: Techniques to prevent overfitting.
Optimizer type 612: Choice of optimization technique (e.g., Adam, SGD).
Learning rate decay 614: Reduces the learning rate over time to refine training.

Training 616:
Input layer 618: The initial layer receiving input data.
Hidden layers 620: Intermediate layers that abstract features.
Output layer 622: The final layer that produces predictions.
Activation functions 624: Functions applied to nodes to introduce non-linearity.
Network depth 626: Number of layers in the network.
Weight initialization 628: Strategy for starting weights of the network.

Model evaluation 630:
Reward over time 632: Cumulative reward in reinforcement learning.
Resource utilization 634: Efficiency of resource usage.
Training loss 636: Measure of error during training.
Latency reduction 638: Decrease in response time.
QoS compliance 640: Adherence to Quality-of-Service requirements.
Model robustness 642: Stability under various conditions.
Scalability testing 644: Performance under increased load.
Generalization error 646: Error on unseen data.
Performance metrics 648: Various metrics to evaluate model performance.

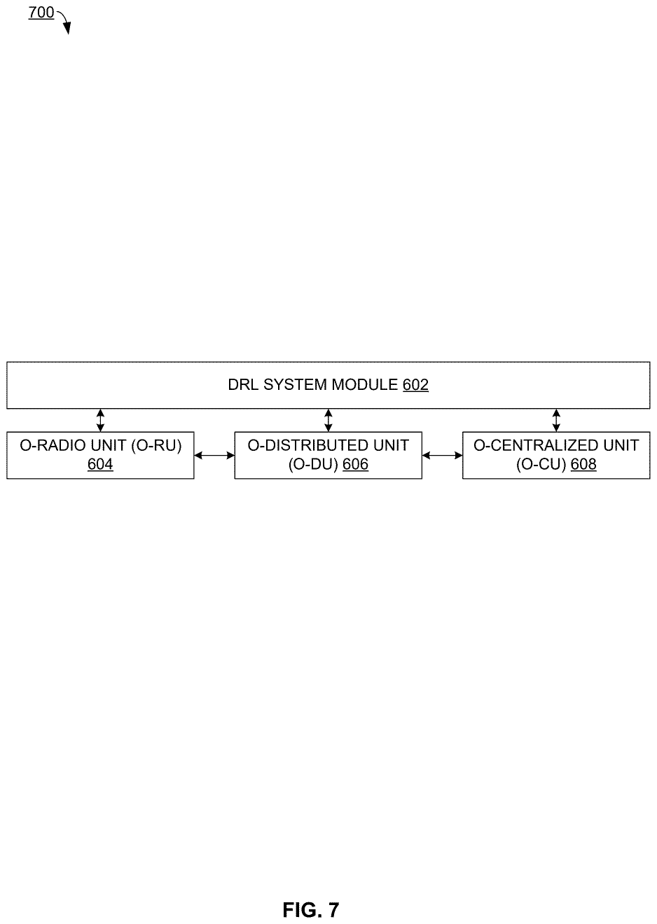

FIG. 7 illustrates an example 700 of physically integrating cellular network slicing with reinforcement learning and proximal policy optimization into an Open Radio Access Network (O-RAN) architecture, in accordance with an embodiment of this disclosure. In some examples, part(s) of example 700 can be implemented by part(s) of system architecture 100 of FIG. 1 to facilitate cellular network slicing with reinforcement learning and proximal policy optimization.

Physical integration of a DRL system can involve embedding it within the O-RAN architecture's hardware components, which include the O-RU (O-radio unit), O-DU (O-distributed unit), and O-CU (O-central unit). The DRL system can collect data from these components and performs actions to optimize network performance.

Example 700 comprises the following components: DRL system module 702, O-RU 704, O-DU 706, and O-CU 708.

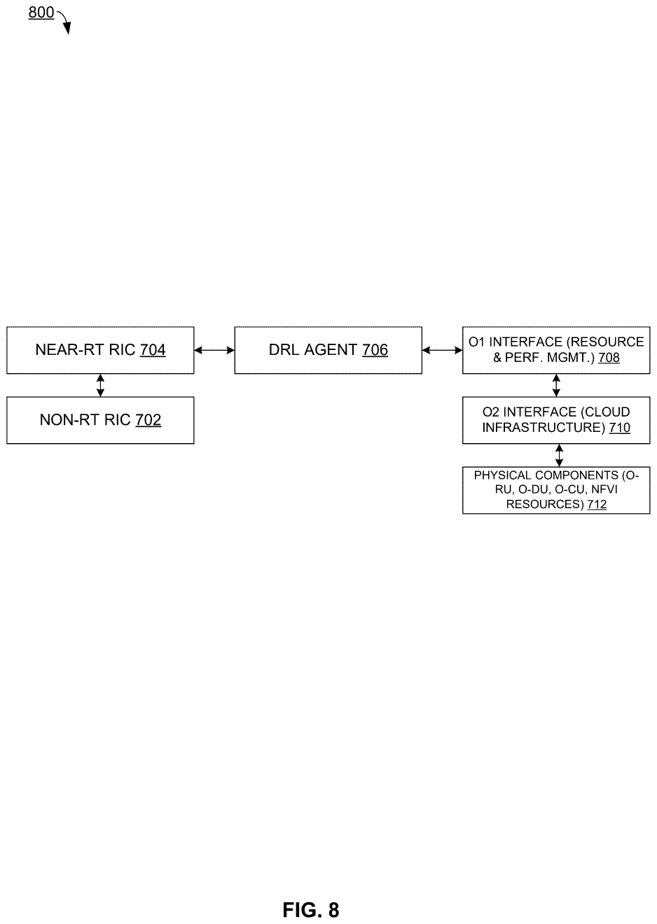

FIG. 8 illustrates an example 800 of logically integrating cellular network slicing with reinforcement learning and proximal policy optimization into an O-RAN architecture, in accordance with an embodiment of this disclosure. In some examples, part(s) of example 800 can be implemented by part(s) of system architecture 100 of FIG. 1 to facilitate cellular network slicing with reinforcement learning and proximal policy optimization.

Logical integration of a DRL system can involve embedding the DRL system into the O-RAN logical architecture. This can include the Non-Real-Time RAN Intelligent Controller (RIC) (Non-RT RIC) and Near-Real-Time RIC (Near-RT RIC), as well as the O1 and O2 interfaces for communication and control.

Example 800 comprises the following components:
Non-Real-Time RIC (Non-RT RIC) 802: Utilizes historical data and long-term policies to optimize network performance.
Near-Real-Time RIC (Near-RT RIC) 804: Implements short-term policies and real-time adjustments to manage network slices.
DRL agent 806: Operates within the RIC, making intelligent decisions based on the state space KPIs.
O1 interface 808: Facilitates communication between the DRL system and network management systems to extract KPIs and execute actions.
O2 interface 810: Ensures seamless interaction between the DRL system and the cloud infrastructure for resource management and monitoring.
Physical components 812: Includes the O-RU, O-DU, O-CU, and NFVI resources (Network Functions Virtualization Infrastructure).

An example workflow is as follows:
Data collection: KPIs are collected from the physical components (O-RU, O-DU, O-CU) and processed through the O1 and O2 interfaces.
State representation: The collected data forms the state space for the DRL system.
Action determination: The DRL agent, operating within the RIC, evaluates the current state and determines the optimal actions to take.
Action execution: Actions are executed through the O1 and O2 interfaces, affecting resource allocation, load balancing, QoS adjustments, and other necessary operations.
Reward calculation: The reward function evaluates the effectiveness of the actions based on the updated KPIs.
Learning and Adaptation: The DRL agent learns and adapts its policy over time to improve network performance and resource utilization.

By integrating these components within the O-RAN physical and logical systems, the DRL system can dynamically manage and optimize network slices, facilitating:
Enhanced efficiency: The DRL system can continuously monitor and adjust resource allocation, leading to optimal utilization of network resources. This can result in improved efficiency and the ability to handle higher loads without degradation in performance.
Adaptive performance: The DRL system can adapt to changing network conditions and user demands in real-time. This dynamic adjustment capability can ensure that the network can maintain high performance levels even during peak usage times or unexpected demand spikes.
Improved Quality of Service (QoS): By leveraging the DRL system's decision-making capabilities, the network can prioritize critical traffic, reduce latency, and ensure reliable communication. This can facilitate services requiring high QoS, such as eMBB, URLLC, and mMTC.
Scalability: The integration of the DRL system can allow the network to scale efficiently. As the number of connected devices and the volume of data traffic increase, the system can manage the additional load without compromising service quality.
Energy efficiency: The DRL system can implement energy-saving strategies by optimizing the operation of network components. This can reduce operational costs, and also align with sustainable practices by minimizing energy consumption.
Proactive maintenance: By analyzing historical data and identifying patterns, the DRL system can predict potential failures and performance issues before they occur. This proactive approach to maintenance can help in avoiding downtime and maintaining continuous service availability.

### Example Process Flows

FIG. 9 illustrates an example process flow 900 that can facilitate cellular network slicing with reinforcement learning and proximal policy optimization, in accordance with an embodiment of this disclosure. In some examples, one or more embodiments of process flow 900 can be implemented by cellular network slicing with reinforcement learning and proximal policy optimization component 106 of FIG. 1, or computing environment 1200 of FIG. 12.

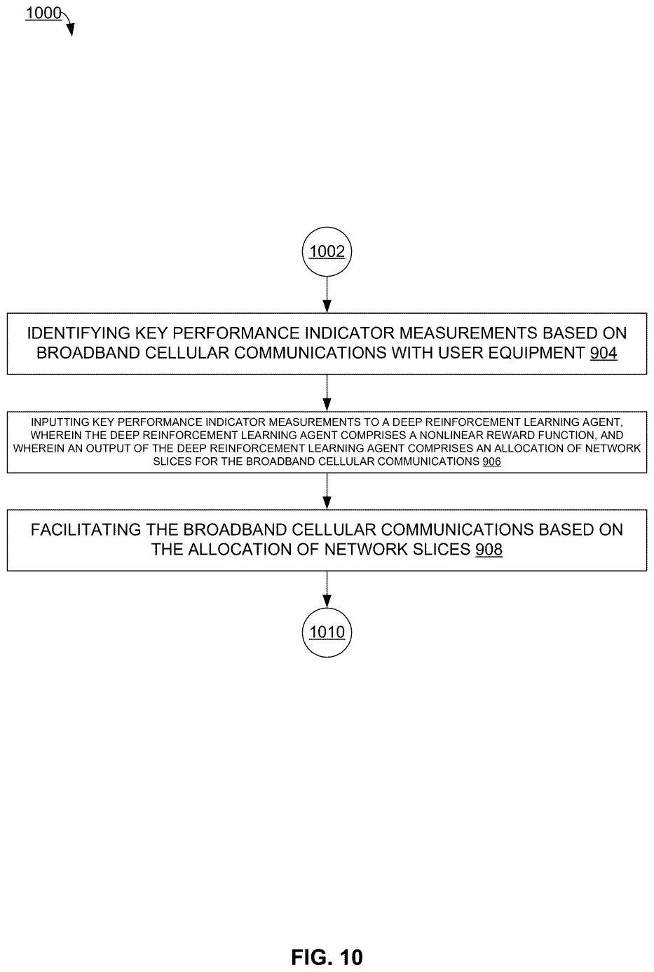

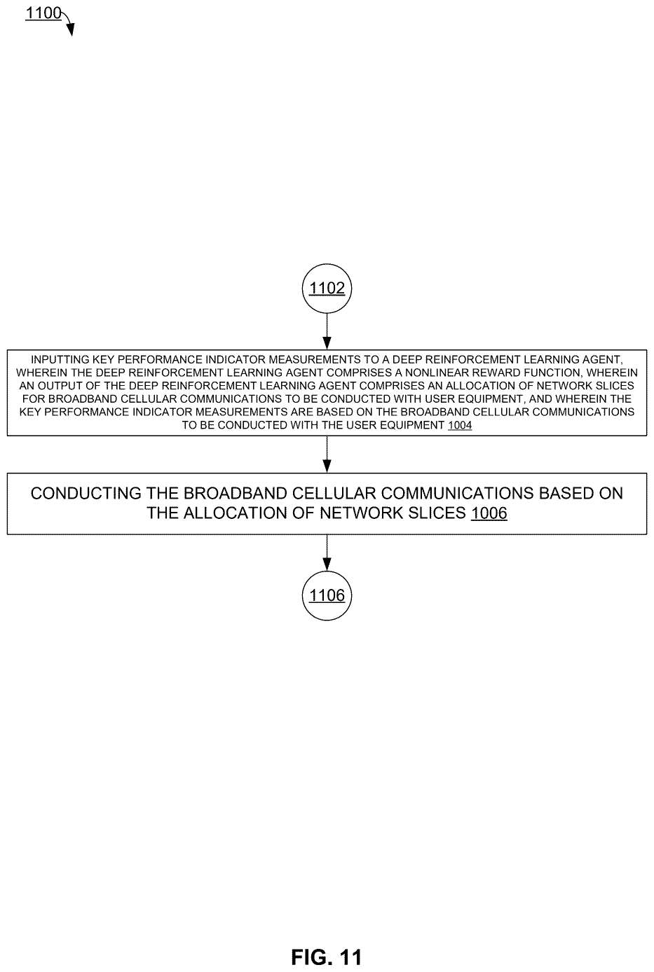

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 1000 of FIG. 10, and/or process flow 1100 of FIG. 11.

Process flow 900 begins with 902, and moves to operation 904.

Operation 904 depicts identifying a group of key performance indicator measurements based on broadband cellular communications to be communicated to a group of user equipment. Using the example of FIG. 1, this can comprise cellular network slicing with reinforcement learning and proximal policy optimization component 106 receiving real-time KPI measurements from the cellular network provided by base station 102 and to which UEs 104 are attached.

In some examples, the group of key performance indicator measurements comprises respective measurements in a sliding time window. In some examples, the group of key performance indicator measurements comprises respective measurements according to an exponentially weighted moving average. That is, in some examples, a sliding window or exponentially weighted moving average (EWMA) can be used to determine time-averaged KPI values for stability and reliability in decision-making.

After operation 904, process flow 900 moves to operation 906.

Operation 906 depicts inputting the group of key performance indicator measurements to a deep reinforcement learning agent, wherein the deep reinforcement learning agent comprises a nonlinear reward function, and wherein an output of the deep reinforcement learning agent comprises an allocation of network slices for the broadband cellular communications. That is, a nonlinear reward function can be computed by a DRL agent based on the KPIs of operation 904.

In some examples, the nonlinear reward function comprises a quadratic transformation of at least one key performance indicator measurement of the group of key performance indicator measurements. In some examples, the nonlinear reward function comprises an exponential transformation of at least one key performance indicator measurement of the group of key performance indicator measurements. In some examples, the nonlinear reward function penalizes a deviation of at least one key performance indicator measurement of the group of key performance indicator measurements from at least one target measurement. That is, the reward function can be nonlinear, and can include quadratic and/or exponential transformations of KPIs to penalize large deviations from optimal (or satisfactory) values.

After operation 906, process flow 900 moves to operation 908.

Operation 908 depicts communicating the broadband cellular communications to the group of user equipment based on the allocation of network slices. That is, allocation of network slices and resources can be made based on the determined reward function of operation 906.

After operation 908, process flow 900 moves to 910, where process flow 900 ends.

FIG. 10 illustrates an example process flow 1000 that can facilitate cellular network slicing with reinforcement learning and proximal policy optimization, in accordance with an embodiment of this disclosure. In some examples, one or more embodiments of process flow 1000 can be implemented by cellular network slicing with reinforcement learning and proximal policy optimization component 106 of FIG. 1, or computing environment 1200 of FIG. 12.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of one or more of process flow 900 of FIG. 9, and/or process flow 1100 of FIG. 11.

Process flow 1000 begins with 1002, and moves to operation 1004.

Operation 1004 depicts identifying key performance indicator measurements based on broadband cellular communications with user equipment. In some examples, operation 1004 can be implemented in a similar manner as operation 904 of FIG. 9.

In some examples, a key performance indicator measurement of the key performance indicator measurements comprises a network load measurement. This can be network load as described herein.

In some examples, a key performance indicator measurement of the key performance indicator measurements comprises a slice utilization measurement. This can be slice utilization as described herein.

In some examples, a key performance indicator measurement of the key performance indicator measurements comprises a user demand measurement. This can be user demand as described herein.

In some examples, a key performance indicator measurement of the key performance indicator measurements comprises a link quality measurement. This can be link quality as described herein.

In some examples, a key performance indicator measurement of the key performance indicator measurements comprises a latency measurement. This can be latency as described herein.

In some examples, a key performance indicator measurement of the key performance indicator measurements comprises a resource availability measurement. This can be resource availability as described herein.

In some examples, a key performance indicator measurement of the key performance indicator measurements comprises an energy consumption measurement. This can be energy consumption as described herein.

In some examples, a key performance indicator measurement of the key performance indicator measurements comprises a quality of service deviation measurement. This can be QoS deviation as described herein.

After operation 1004, process flow 1000 moves to operation 1006.

Operation 1006 depicts inputting key performance indicator measurements to a deep reinforcement learning agent, wherein the deep reinforcement learning agent comprises a nonlinear reward function, and wherein an output of the deep reinforcement learning agent comprises an allocation of network slices for the broadband cellular communications. In some examples, operation 1006 can be implemented in a similar manner as operation 906 of FIG. 9.

After operation 1006, process flow 1000 moves to operation 1008.

Operation 1008 depicts facilitating the broadband cellular communications based on the allocation of network slices. In some examples, operation 1008 can be implemented in a similar manner as operation 908 of FIG. 9.

After operation 1008, process flow 1000 moves to 1010, where process flow 1000 ends.

FIG. 11 illustrates an example process flow 1100 that can facilitate cellular network slicing with reinforcement learning and proximal policy optimization, in accordance with an embodiment of this disclosure. In some examples, one or more embodiments of process flow 1100 can be implemented by cellular network slicing with reinforcement learning and proximal policy optimization component 106 of FIG. 1, or computing environment 1200 of FIG. 12.

It can be appreciated that the operating procedures of process flow 1100 are example operating procedures, and that there can be embodiments that implement more or fewer operating procedures than are depicted, or that implement the depicted operating procedures in a different order than as depicted. In some examples, process flow 1100 can be implemented in conjunction with one or more embodiments of one or more of process flow 900 of FIG. 9, and/or process flow 1100 of FIG. 11.

Process flow 1100 begins with 1102, and moves to operation 1104.

Operation 1104 depicts inputting key performance indicator measurements to a deep reinforcement learning agent, wherein the deep reinforcement learning agent comprises a nonlinear reward function, wherein an output of the deep reinforcement learning agent comprises an allocation of network slices for broadband cellular communications to be conducted with user equipment, and wherein the key performance indicator measurements are based on the broadband cellular communications to be conducted with the user equipment. In some examples, operation 1104 can be implemented in a similar manner as operations 904-806 of FIG. 9.

In some examples, the deep reinforcement learning agent normalizes respective key performance indicator measurements of the key performance indicator measurements. That is, each KPI can be assigned a normalized weight to reflect its relative importance, which can facilitate a balanced and comprehensive evaluation of network performance.

In some examples, the nonlinear reward function comprises a piecewise-defined transformation of at least one key performance indicator measurement of the key performance indicator measurements. An example is given above. This approach can allow for linear treatment when the KPI is within acceptable limits, and introduce penalties when the KPI exceeds a certain threshold.

In some examples, the deep reinforcement learning agent is subject to a first constraint indicating a maximum latency, to a second constraint indicating a maximum quality of service deviation, and to a third constraint indicating a maximum energy consumption. This can be as described above.

After operation 1104, process flow 1100 moves to operation 1106.

Operation 1106 depicts conducting the broadband cellular communications based on the allocation of network slices. In some examples, operation 1106 can be implemented in a similar manner as operation 908 of FIG. 9.

In some examples, the allocation of network slices for broadband cellular communications comprises a throughput indicator for instantaneous measurement setting and a throughput energy setting, wherein the throughput indicator for instantaneous measurement setting satisfies a contradiction criterion relative to the throughput energy setting, and operation 1106 comprises adjusting at least one of the throughput indicator for instantaneous measurement setting and the throughput energy setting to satisfy a coordination criterion before conducting the broadband cellular communications based on the allocation of network slices.

After operation 1106, process flow 1100 moves to 1106, where process flow 1100 ends.

### Example Operating Environment

In order to provide additional context for various embodiments described herein, FIG. 12 and the following discussion are intended to provide a brief, general description of a suitable computing environment 1200 in which the various embodiments of the embodiment described herein can be implemented.

For example, parts of computing environment 1200 can be used to implement one or more embodiments of base station 102, and/or UEs 104.

In some examples, computing environment 1200 can implement one or more embodiments of the process flows of FIGS. 9-11 to facilitate cellular network slicing with reinforcement learning and proximal policy optimization.

While the embodiments have been described above in the general context of computer-executable instructions that can run on one or more computers, those skilled in the art will recognize that the embodiments can also be implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12, the example environment 1200 for implementing various embodiments described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a nonvolatile storage such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD) 1216, a memory stick or flash drive reader, a memory card reader, etc.) and an optical disk drive 1220 (e.g., which can read or write from a CD-ROM disc, a DVD, a BD, etc.). While the internal HDD 1214 is illustrated as located within the computer 1202, the internal HDD 1214 can also be configured for external use in a suitable chassis (not shown). Additionally, while not shown in environment 1200, a solid state drive (SSD) could be used in addition to, or in place of, an HDD 1214. The HDD 1214, external storage device(s) 1216 and optical disk drive 1220 can be connected to the system bus 1208 by an HDD interface 1224, an external storage interface 1226 and an optical drive interface 1228, respectively. The interface 1224 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the .NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, etc.

A monitor 1246 or other type of display device can also be connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are examples, and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches, and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations,” this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
identifying a group of key performance indicator measurements based on broadband cellular communications to be communicated to a group of user equipment;
inputting the group of key performance indicator measurements to a deep reinforcement learning agent, wherein the deep reinforcement learning agent comprises a nonlinear reward function, and wherein an output of the deep reinforcement learning agent comprises an allocation of network slices for the broadband cellular communications; and
communicating the broadband cellular communications to the group of user equipment based on the allocation of network slices.

2. The system of claim 1, wherein the nonlinear reward function comprises a quadratic transformation of at least one key performance indicator measurement of the group of key performance indicator measurements.

3. The system of claim 1, wherein the nonlinear reward function comprises an exponential transformation of at least one key performance indicator measurement of the group of key performance indicator measurements.

4. The system of claim 1, wherein the nonlinear reward function penalizes a deviation of at least one key performance indicator measurement of the group of key performance indicator measurements from at least one target measurement.

5. The system of claim 1, wherein the group of key performance indicator measurements comprises respective measurements in a sliding time window.

6. The system of claim 1, wherein the group of key performance indicator measurements comprises respective measurements according to an exponentially weighted moving average.

7. A method, comprising:
identifying, by a system comprising at least one processor, key performance indicator measurements based on broadband cellular communications with user equipment;
inputting, by the system, key performance indicator measurements to a deep reinforcement learning agent, wherein the deep reinforcement learning agent comprises a nonlinear reward function, and wherein an output of the deep reinforcement learning agent comprises an allocation of network slices for the broadband cellular communications; and
facilitating, by the system, the broadband cellular communications based on the allocation of network slices.

8. The method of claim 7, wherein a key performance indicator measurement of the key performance indicator measurements comprises a network load measurement.

9. The method of claim 7, wherein a key performance indicator measurement of the key performance indicator measurements comprises a slice utilization measurement.

10. The method of claim 7, wherein a key performance indicator measurement of the key performance indicator measurements comprises a user demand measurement.

11. The method of claim 7, wherein a key performance indicator measurement of the key performance indicator measurements comprises a link quality measurement.

12. The method of claim 7, wherein a key performance indicator measurement of the key performance indicator measurements comprises a latency measurement.

13. The method of claim 7, wherein a key performance indicator measurement of the key performance indicator measurements comprises a resource availability measurement.

14. The method of claim 7, wherein a key performance indicator measurement of the key performance indicator measurements comprises an energy consumption measurement.

15. The method of claim 7, wherein a key performance indicator measurement of the key performance indicator measurements comprises a quality of service deviation measurement.

16. A non-transitory computer-readable medium comprising instructions that, in response to execution, cause a system comprising at least one processor to perform operations, comprising:
inputting key performance indicator measurements to a deep reinforcement learning agent, wherein the deep reinforcement learning agent comprises a nonlinear reward function, wherein an output of the deep reinforcement learning agent comprises an allocation of network slices for broadband cellular communications to be conducted with user equipment, and wherein the key performance indicator measurements are based on the broadband cellular communications to be conducted with the user equipment; and
conducting the broadband cellular communications based on the allocation of network slices.

17. The non-transitory computer-readable medium of claim 16, wherein the deep reinforcement learning agent normalizes respective key performance indicator measurements of the key performance indicator measurements.

18. The non-transitory computer-readable medium of claim 16, wherein the nonlinear reward function comprises a piecewise-defined transformation of at least one key performance indicator measurement of the key performance indicator measurements.

19. The non-transitory computer-readable medium of claim 16, wherein the deep reinforcement learning agent is subject to a first constraint indicating a maximum latency, to a second constraint indicating a maximum quality of service deviation, and to a third constraint indicating a maximum energy consumption.

20. The non-transitory computer-readable medium of claim 16, wherein the allocation of network slices for broadband cellular communications comprises a first power transmission setting and a second power transmission setting, wherein the first power transmission setting satisfies a contradiction criterion relative to the second power transmission setting, and wherein the operations further comprise:
adjusting at least one of the first power transmission setting and the second power transmission setting to satisfy a coordination criterion before conducting the broadband cellular communications based on the allocation of network slices.
